(19) United States
(12) Patent Application Publication
(10) Pub. No.: US 2017/0138517 A1
(43) Pub. Date: May 18, 2017

(54) COUPLING ELEMENT FOR CONNECTING FLUID CONDUCTING CONDUITS AND CORRESPONDING COUPLING ARRANGEMENT

(71) Applicant: AUDI AG, 85045 lngolstadt (DE)

(72) Inventor: MARKUS ARNOLD, Buchen (DE)

(73) Assignee: AUDI AG, 85045 lngolstadt (DE)

(21) Appl. No.: 15/350,450

(22) Filed: Nov. 14, 2016

(30) Foreign Application Priority Data
Nov. 14, 2015 (DE) 10 2015 014 816.8

(51) Int. Cl. F16L 29/02; F16K 27/02; F16K 15/18; F16K 15/02

(52) U.S. Cl. CPC F16L 29/02; F16K 15/026; F16K 27/0209; F16K 15/18

(57) ABSTRACT

A coupling element for connecting a first conduit with a second conduit, includes a tubular body, a valve element arranged in the tubular body for displacement between a sealing position in which the valve element interacts with a valve seat thereby closing the coupling element, and a release position in which the valve element releases a flow connection through the coupling element; and at least one actuating arm engaging on the valve element, said at least one actuating arm traversing a wall of the tubular body in a radial direction and protruding radially over the tubular body so that when a counter coupling element coupled with the second conduit or the second conduit is pushed onto the coupling element the counter coupling element or the second conduit exerts a force on the actuating arm so that the valve element is urged from the sealing position in a direction of the release position.

### CROSS-REFERENCES TO RELATED APPLICATIONS

This application claims the priority of German Patent Application, Serial No. 10 2015 014 816.8, filed Nov. 14, 2015, pursuant to 35 U.S.C. 119(a)-(d), the content of which is incorporated herein by reference in its entirety as if fully set forth herein.

### BACKGROUND OF THE INVENTION

The invention relates to a coupling element for connecting a first fluid conducting conduit with a second fluid conducting conduit.

The coupling element is preferably a component of a coupling arrangement by means of which the two fluid conducting conduits, i.e., the first conduit and the second conduit can be connected with each other. The two conduits may also be connected solely by means of the coupling element. For connecting the fluid conducting conduits the coupling element is connected with the first conduit and is correspondingly configured for connection with the first conduit. Subsequently the coupling element can for example be introduced into the coupling element and coupled with the coupling element. The coupling is for example accomplished by means of a form fit connection or rear grip connection by which the coupling element is reliably and permanently fixed relative to the counter coupling element.

As an alternative the coupling element itself may be introduced into the second conduit in the absence of the counter coupling element. Also in such an embodiment the coupling can be provided, i.e., between the coupling element and the second conduit. The second conduit may for example be arranged on the coupling element with a force fit, i.e., it engages around the coupling element so that the coupling element cannot be removed from the second conduit, or can only be from the second conduit by applying a targeted force. In addition or as an alternative a coupling means can be provided by which the second conduit is fastened on the coupling element or vice versa. The coupling means is for example a clamping ring, a tube bracket or the like.

In order to prevent leakage of the fluid present in the first conduit, the coupling element has a leak protection. The leak protection has a valve element which is arranged for displacement in the tubular body of the coupling element. The term tubular body preferably means a substantially tubular element, which has for example dimensions in axial direction with respect to a longitudinal center axis of the coupling element that are greater than its dimensions in radial direction. In other words the tubular body has a ratio of length to diameter of greater than one, greater than two, greater than four or greater than five.

The valve element may be inserted in the tubular body or supported in the tubular body. For example it is displaceable in axial direction. The valve element can be arranged in different positions, at least however in the sealing position and the release position. In the sealing position the valve element rests against the valve seat so that the coupling element is closed so that the fluid present in the first fluid conducting conduit cannot exit through the coupling element.

It would be desirable and advantageous to provide a coupling element that has advantages compared to known coupling elements and in particular a more reliable leak protection of the coupling element.

### SUMMARY OF THE INVENTION

According to one aspect of the present invention a coupling element for connecting a first fluid conducting conduit with a second fluid conducting conduit, including: a tubular body having a wall; a leak protection including a valve element arranged in the tubular body and displaceable in the tubular body between a sealing position in which the valve element rests against a valve seat to inhibit a fluid flow through the coupling element, and a release position in which the valve element is removed from the valve seat to permit a fluid flow through the coupling element; and an actuating arm operably connected to the valve element, wherein the actuating arm is configured to traverse the wall of the tubular body in a radial direction and to extend beyond the tubular body in the radial direction so as to allow application of a force to move the valve element from the sealing position towards the release position.

According to another advantageous feature of the invention, the coupling element is constructed for connection into the second fluid conducting conduit, said valve element moving from the sealing position to the release position, when the force is applied as the second fluid conducting conduit is pushed onto the coupling element.

According to another advantageous feature of the invention, the coupling element is constructed for connection into a counter coupling element which is coupled with the second conduit, said valve element moving from the sealing position to the release position, when the force is applied as the counter coupling element is pushed onto the coupling element.

Thus a special configuration of the leak protection is provided which is not based on an interaction between the coupling element and the counter coupling element of the second line but rather has an external actuating element i.e., the actuating arm which protrudes out of the tubular body of the coupling element so that it can be actuated form an external environment of the coupling element. By means of the actuating arm a reliable displacement of the valve element is achieved so that when introducing the coupling element into the counter coupling element or the second conduit a reliable release of the flow connection through the coupling element is realized. It can also be easily verified from the outside whether the connection between the coupling element on the one hand and the counter coupling element or the second conduit on the other hand is properly established and/or whether the valve element is in the sealing position or in the release position.

Relative to the longitudinal center axis of the coupling element the at least one actuating arm extends at least partially in radial direction outward so that it traverses the tubular body. The valve element is preferably arranged entirely in the tubular body. In particular the valve element is in each position between the sealing position and the release position situated completely in the tubular body. On the tubular body the actuating arm engages which protrudes out of the tubular body, i.e. traverses a wall of the tubular body in radial direction. Hereby the actuating arm protrudes in radial direction over the tubular body so that the counter coupling element or the second conduit interact with the actuating arm and impinge the actuating arm with a force so that the valve element is urged n the direction of the release position.

The actuating arm and the valve element can be configured separate from each other and subsequently be arranged on each other and/or fastened to each other. The actuating arm and the valve element may also be configured one-piece and/or made of the same material. The actuating arm and the valve element may also be displaced relative to each other after the mounting of the coupling element.

According to another advantageous feature of the invention, the tubular body can have an actuating receptacle for the actuating arm which is formed with a closed border in a wall of the tubular body and completely traverses the wall in radial direction. The actuating receptacle is traversed by the actuating arm, in particular in radial direction completely. The actuating receptacle is present with a closed border tin the wall, i.e., it has a continuous border. The actuating receptacle is for example configured slot-shaped or as an oblong hole or stadium like.

The actuating receptacle has dimensions in axial direction, which enable a displacement of the valve element or the actuating arm engaging on the valve element at least between the sealing position and the release position. It can be provided that the border of the actuating receptacle forms at least one end stop, which is either assigned to the sealing position or to the release position. Correspondingly the actuating arm, when the valve element is position in the sealing position or the release position reset against the end stop, which prevents a further displacement in this direction. Of course it can also be provided that the sealing position and also the release position a respective such end stop is assigned.

Generally it is sufficient to provide a single actuating arm. Preferably however multiple actuating arms are arranged or fastened in the valve element. Preferably each actuating arm is assigned a separate actuating receptacle. The actuating receptacles are insofar spaced apart from each of the in circumferential direction. For example the actuating arms and correspondingly the actuating receptacles are arranged uniformly distributed over the circumference of the valve element. Preferably two respective actuating arms are provided diametrically opposed to each other on the valve element.

According to another advantageous feature of the invention, the actuating receptacle fixes the actuating arm assigned to it in circumferential direction. For this purpose the actuating receptacle has dimensions in circumferential direction, which correspond to the dimensions of the actuating arm in circumferential direction or are at most slightly great. Ideally the actuating arm thus when arranged in the actuating receptacle rests against the border of the actuating receptacle at sides that are opposite each other in circumferential direction.

According to another advantageous feature of the invention, adjacent to the actuating receptacle a latching element is arranged which can interact with a counter latching element of the counter coupling element in order to fix the coupling element relative to the counter coupling element or serves as an end stop for the second conduit. The latching element serves for fixing the coupling element relative to the counter coupling element or in the counter coupling element. For example the counter coupling element has rear grip means, which engage behind the latching element as soon as the coupling element is sufficiently far arranged in the counter coupling element. Preferably the latching element is configured as a radial protrusion in particular as radial annular protrusion. When the second conduit is only pushed onto the counter coupling element, i.e., the use of the counter coupling element is not provided, the latching element can also serve as end stop for the second conduit. In this case, after pushing on the second conduit onto the coupling element an end face of the second conduit rests against the latching element.

According to another advantageous feature of the invention, the latching element can have in axial direction the same dimensions as an actuating region of the actuating element that is situated outside the tubular body. The actuating region of the actuating element is the region of the actuating element which is outside the tubular body, i.e., which interacts with the counter coupling element or the second conduit for displacement of the valve element. When the latching element and the actuating region have in axial direction the same dimensions they can overlap each other at least in one position of the sealing element.

According to another advantageous feature of the invention, in addition or as an alternative the actuating region is aligned at least on one side with the latching element when viewed in axial direction and/or in radial direction when the valve element is arranged in the release position. Particularly preferably the actuating region is aligned with the latching element in axial direction on both sides when the valve element is in the release position. However, it can also be provided, either in addition or as an alternative, that the actuating region extends in radial direction from the tubular body as far as to the latching element so that they align with each other at the outside when viewed in radial direction.

According to another advantageous feature of the invention, the actuating region can form a circumferential annular web together with the latching element when the valve element is in the release position. This is in particular the case when the actuating region is aligned with the latching element in axial direction on both sides and (optionally) in radial direction outside. Preferably the latching element additionally extends up to the actuating arm receptacle in which the actuating arm that has the actuating region is arranged. Correspondingly the actuating region and the latching element can form the circumferential annular web.

According to another advantageous feature of the invention, the valve element has a bearing part, wherein a has a ratio of dimensions of the bearing part in axial direction to a ratio of dimensions of the bearing part dimensions in radial direction is at least 1.5, at least 1.75, at least 2.0, at least 2.25 or at least 2.5, and has at least two bearing surfaces that are spaced apart in axial direction and which each rest against an inner circumferential surface of the tubular body. The bearing part of the valve element is arranged completely in the tubular body. It serves for supporting or guiding the valve element in the tubular body.

For this purpose a ratio between dimensions of the bearing part in axial direction and the dimensions of the bearing part in radial direction enables a reliable support. Hereby in particular the dimensions in axial direction are grater than the dimensions in radial direction preferably they have the mentioned minimal ratios. The bearing part has insofar preferably a ratio of length to diameter of at least one. On the baring part at least two bearing surfaces are provided which serve of supporting the valve element in the tubular body. These bearing surfaces are spaced apart from each other in axial direction in order to prevent a tilting of the valve element. The bearing surfaces are preferably in full surface contact with the inner circumferential surface of the tubular body in particular continuous in circumferential direction.

According to another advantageous feature of the invention, when viewed in axial direction a sealing is arranged on both sides of the actuating arm receptacle. The sealing serves for sealing the actuating arm receptacle against the remaining regions of the tubular body so that the fluid cannot leak through the actuating arm receptacle out of the tubular body. Each of the sealings can either be arranged on the tubular body or on the vale element in particular the bearing part. For example the tubular body r the valve element has for this purpose corresponding sealing receptacles. When the sealings are arranged on the valve element this is preferably implemented so that the sealings are present on both sides of the actuating receptacle or the actuating arm receptacle in the sealing position as well as in the release position.

According to another advantageous feature of the invention, the valve element has a closing part, which in the sealing position rests against the vale seat and in the release position is spaced apart form the valve seat. Beside the bearing part insofar preferably the closing part is provided. The closing part serves for interrupting the flow connection through the coupling element in the sealing position or for releasing the flow connection in the release position. For example it is provided that the closing part is arranged on the side of the vale seat that faces away from the bearing part. The closing part and the bearing part are arranged spaced apart from each other in axial direction or directly border each other in axial direction. In each case the closing part is preferably at least partially arranged on a first side of the valve seat, while the bearing part is at least partially situated on a second side of the valve seat that is opposite the first side.

According to another advantageous feature of the invention, the valve element, in particular the closing part is impinged by means of a spring force which urges the vale element in the direction of the sealing position. On the valve element or the closing part insofar the spring engages. The spring causes the spring force, which urges the vale element in the direction of the sealing position. Preferably the spring is under pre-tension so that also when the valve element is arranged in its sealing position a spring force is present which urges the valve element into the sealing position or releasing it in the sealing position, i.e., presses the closing part into the valve seat.

According to another advantageous feature of the invention, the spring at is side that faces away form the valve element engages on a latching body, which is latchingly fastened in the tubular body, and is in particular supported on the tubular body. For example the latching body has latching arms which protrude in radial direction outward and engage in latching recesses which are formed in the tubular body in order to reliable hold the latching body in axial direction in the tubular body. It can also be provide that the latching body has a contact surface with which it rests against the tubular conduit after being introduced into the coupling element in order to further increase the stability.

According to another advantageous feature of the invention, the bearing part is traversed in axial direction by a flow channel which is in flow communication with a radial channel that is formed between the bearing part and the closing part. The radial channel is hereby arranged so that it is situated on the side of the vale seat that faces away form the first conduit when the valve element is arranged in the sealing position. Correspondingly a flow communication is interrupted between the first conduit and the radial channel. When the valve element is displace out of the sealing position, in particular as far as into the release position, the flow connection is at least partially, in particular completely established so that fluid can flow form the first conduit into the radial channel. Through the radial channel the fluid reaches the flow channel, which completely traversed the bearing part in axial direction. For the flow channel the fluid can now reach the side of the coupling element that faces way form the valve seat and flow into the counter coupling element and/or the second conduit.

According to another advantageous feature of the invention, the bearing part and the closing part are connected with each other via at least one web, wherein the radial channel is present beside the web or is formed in the web. Preferably the bearing part and the closing part are spaced apart by means of the web. Via the web the bearing part and the closing part are connected for example rigidly with each other. It can be provided that only a single web is present. As an alternative of course multiple webs can be realized that are distributed over the circumference of the bearing part or the closing part. The radial channel can be present beside the web in particular arranged between two webs. As an alternative the radial channel can also be formed in the web, i.e., traverse the web in radial direction.

According to another aspect of the invention a coupling arrangement for connecting a first fluid conducting conduit with a second fluid conducting conduit includes: a coupling element, wherein the coupling element includes a tubular body, a leak protection including a valve element arranged in the tubular body and displaceable in the tubular body between a sealing position in which the valve element rests against a valve seat to inhibit a fluid flow through the coupling element, and a release position in which the valve element is removed from the valve seat to permit a fluid flow through the coupling element; and an actuating arm operably connected to the valve element, wherein the actuating arm is configured to traverse a wall of the tubular body in a radial direction and to extend beyond the tubular body in the radial direction; and a counter coupling element, wherein the counter coupling element engages with the actuating when the counter coupling is pushed onto the coupling arm so that the valve element is urged from the sealing position in a direction of the release position.

The advantages of such an embodiment of the coupling arrangement or the coupling element have be mentioned above. The coupling arrangement as well as the coupling element can be modified according to the description above so that insofar reference is made therefore. The coupling arrangement has preferably beside the coupling element the counter coupling element. By means of the leak protection a leaking of fluid out of the coupling element is effectively prevented. It is particularly provided that also a leak protection is assigned to the counter coupling element so that also fluid cannot leak unwantedly out of the counter coupling element.

### BRIEF DESCRIPTION OF THE DRAWING

Other features and advantages of the present invention will be more readily apparent upon reading the following description of currently preferred exemplified embodiments of the invention with reference to the accompanying drawing, in which

FIG. 1 shows a longitudinal sectional view o though a coupling element wherein a valve element of a leak protection is arranged in a sealing position, and

FIG. 2 shows the coupling element, which engages in a counter coupling element, wherein the valve element is arranged in a release position.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

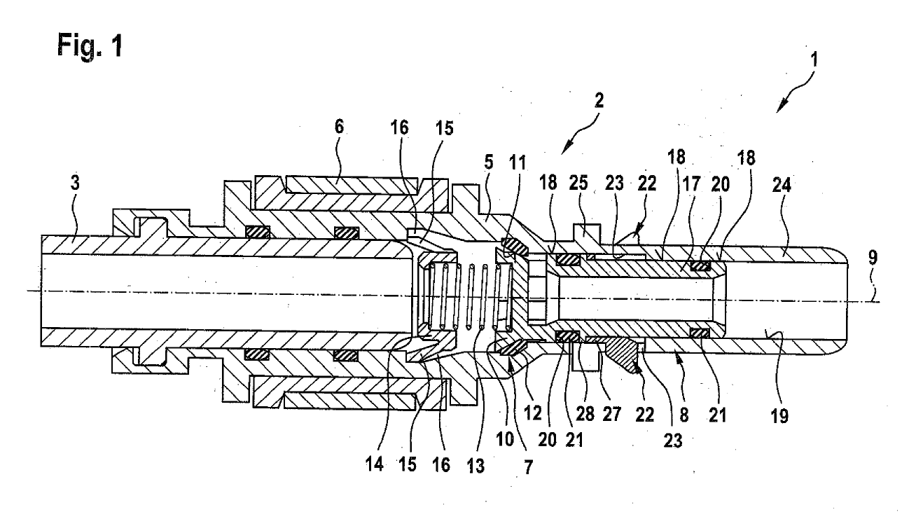

FIG. 1 shows a part of a coupling arrangement 1, i.e., a coupling element 2. The coupling arrangement 1 serves for connecting a first fluid conducting conduit 3 with a here not shown second conduit 4. The first conduit 3 is hereby arranged in the coupling element 2 or can be connected therewith. In particular the first conduit 3 is inserted into the coupling element 2 where it is held in a form fitting manner. The coupling element 2 has a tubular body 5 which can for example be fastened by mean s of a tube bracket 6 or the like, for example on a motor vehicle part.

In order to prevent leakage of a fluid out of the first conduit or the coupling element 2 when the coupling element 2 is not connected with the second conduit 4 a leak protection 7 is proved. The leak protection has a valve element 8, which is supported for displacement in the tubular body 5, in particular in axial direction relative to a longitudinal center axis 9 of the coupling element 2. The valve element 8 in particular a closing part 10 of the vale element 8 interacts in a closing position with a valve seat 11 in order to interrupt a flow connection through the coupling element 2 or to close the coupling element 2 so that no fluid can exit from the first conduit 3 though the coupling element 2.

When on the other hand the valve element 8 is displaced out of the sealing position, in particular into the release position the flow connection though the coupling element 2 is released. In the release position the closing part 10 insofar is spaced apart from the valve seat 1. The valve seat 11 can for example be formed by the coupling element 2 or the tubular body 5 itself. However particular preferably a valve seat element 12 is inserted into the tubular body 5 by which the valve seat 11 is formed. The valve seat element 12 is preferably formed by a more elastic material than the tubular body 5 so that the sealing effect is improved.

The valve element 8 is impinged by a spring 13 with a spring force, which urges the valve element 8 in the direction of the sealing position or into the sealing position. On the side of the spring which faces away form the valve element 8 the spring 13 is for example supported on a latching body 14 which is form fittingly in the tubular body 5 by means of one or multiple latching elements 15 or latching arms. For example the latching element 15 or the latching elements 15 for this purpose engage in latching recesses 16 that are formed in the tubular body 5.

Beside the closing part 10 the valve element 8 has a bearing part 17. The bearing part is preferably completely arranged in the cylindrical, in particular circular cylindrical, region of the tubular body 5 and serves for reliable support of the valve element 8. The bearing part 17 has at least two bearing surfaces 18 that are spaced apart in axial direction relative to he longitudinal center axis 9 and rest against an inner circumferential surface 19 of the tubular body 5 for supporting the valve element 8, in particular continuous in circumferential direction. On the bearing part 17 sealing receptacles 20 with gaskets 21 arranged therein can be formed. The gaskets 21 are preferably configured as sealing rings, i.e., they completely embrace the vale element 8 in circumferential direction. The gaskets 21 hereby rest on one side sealingly against the vale element 8 and on the other side sealingly in the inner circumferential surface 19 of the tubular body 5.

For displacement f he valve element 8 form the sealing position in the direction of the release position or into the release position at least one actuating arm 22 is provided in the here shown exemplary embodiment multiple actuating arms 22. When multiple actuating arms 22 are present these are preferably arranged evenly distributed over the circumference of the vale element 8. In the following only always one actuating arm 22 is discussed. Of course according to the description above multiple actuating arms 22 can be present.

The actuating arm 22 protrudes out of the tubular body 5, in particular in radial direction. It traversed for this an actuating arm receptacle 23, which is formed in the tubular body 5. Preferably each of the actuating arms 22 is assigned such an actuating arm receptacle 23. The actuating arm receptacle 23 is present with a closed border in a wall 24 of the tubular body 5 and traverses this wall completed in radial direction. For example the actuating arm receptacle 23 is hereby configured so that it fixes the actuating arm 22 in circumferential direction. For this purpose it has the same or similar dimensions in circumferential direction as the actuating arm 22 arranged on it.

Adjacent the actuating arm receptacle 23 a latching element 25 is arranged, in particular formed one-piece with and/or made of the same material as, the tubular body 5. The latching element 25 serves for establishing a form fitting connection between a counter coupling element 26, which is fluidly connected with the second conduit 4 (here not shown) or as an end stop for the second conduit 4 itself.

For example the actuating arm 22 is fastened on a base body 27. When multiple actuating arms 22 are provided for example all actuating arms 22 are fastened in the base body 27 for example one-piece with and/or made of the same material as the base body. The base body 27 can be configured as an annular ring and embrace the valve element 8, in particular the bearing part 17 in circumferential direction at least partially, preferably completely.

Preferably the valve element 8 has a radial protrusion 28 with which the base body 27 can come into contact with one of its end sides. The base body 27 can thus generally be freely displaced together with the actuating arms 23. However, when the base body 27 is displaced in the direction of the radial protrusion 28 and comes into contact with the radial protrusion the base body 27 urges the valve element 8 in the direction of the release position or into the release position upon further displacement. The actuating arms 22 and/or the base body 27 can also be fastened on or be configured one-piece with and/or made of the same material as the valve element 8.

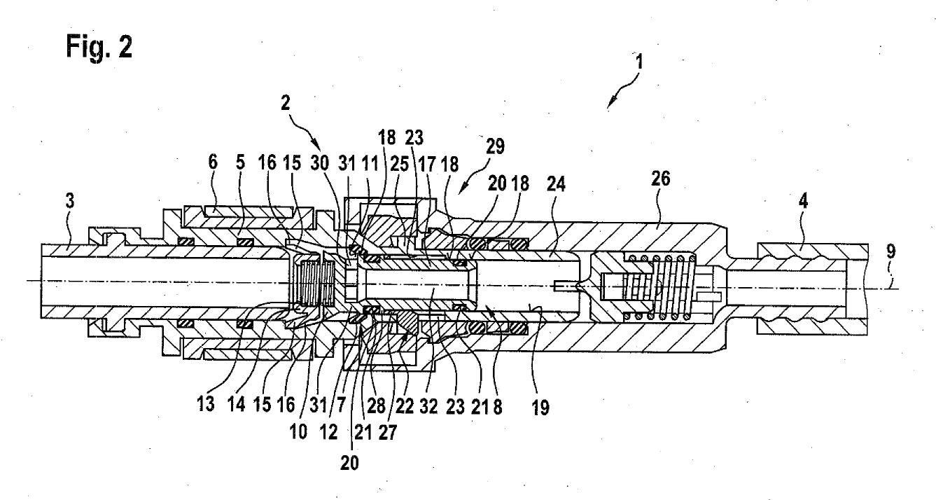

FIG. 2 shows the coupling arrangement 1. Shown is again the coupling element 2 and additionally the counter coupling element 26 with pushed-on second conduit 4. It can be seen that a latching device 29 of the counter coupling element 26 when pushing the counter coupling element 26 onto the coupling element 2 interacts with the actuating arm 22 and urges the actuating arm 22 in the direction of the first conduit 3. Correspondingly the base body 27 is urged against the radial protrusion 28 and the valve element 8 is displaced from the sealing position into the here shown release position. In this release position the flow connection through the coupling element 2 is released. Correspondingly fluid can flow from the first conduit 3 into the second conduit 4.

The flow connection hereby extends through a radial channel 30, which is formed between the bearing part 17 and the closing part 10. For this purpose for example the bearing part 17 and the closing part 10 are interconnected spaced apart by at least one web 31. Preferably the closing part 10, the bearing part 17 and the web 31 are configured one-piece with each other and/or of the same material as each. On the radial channel 30 adjoins a flow channel 32, which is preferably coaxial to the longitudinal center axis 9. The flow channel 32 completely traverses the bearing part 17 in axial direction. Through the radial channel 30 and the flow channel 32 a flow connection between the first conduit 3 and the side of the coupling element 2 that faces away from the first conduit or the coupling element 26 and thus the second conduit 4 is established or can be established.

Particularly preferably the coupling element 2 is entirely made of plastic. In particular the tubular body 5, the valve element 8 and the actuating arm 22 are made of a plastic material, wherein either the same plastic material or different plastic materials can be used.

What is claimed as new and desired to be protected by Letters Patent is set forth in the appended claims and includes equivalents of the elements recited therein:

What is claimed is:

1. A coupling element for connecting a first fluid conducting conduit with a second fluid conducting conduit, said coupling element comprising:
a tubular body having a wall;
a leak protection including a valve element arranged in the tubular body and displaceable in the tubular body between a sealing position in which the valve element rests against a valve seat to inhibit a fluid flow through the coupling element, and a release position in which the valve element is removed from the valve seat to permit a fluid flow through the coupling element; and
an actuating arm operably connected to the valve element, said actuating arm being configured to traverse the wall of the tubular body in a radial direction and to extend beyond the tubular body in the radial direction so as to allow application of a force to move the valve element from the sealing position towards the release position.

2. The coupling element of claim 1, constructed for connection into the second fluid conducting conduit, said valve element moving from the sealing position to the release position, when the force is applied as the second fluid conducting conduit is pushed onto the coupling element.

3. The coupling element of claim 1, constructed for connection into a counter coupling element which is coupled with the second conduit, said valve element moving from the sealing position to the release position, when the force is applied as the counter coupling element is pushed onto the coupling element.

4. The coupling element of claim 1, wherein the tubular body has a receptacle for receiving the actuating arm, said receptacle being formed in the wall of the tubular body with a closed rim and completely traverses the wall in radial direction.

5. The coupling element of claim 4, further comprising a latching element arranged adjacent the receptacle, said latching element being adapted to interact with a counter latching element of the counter coupling element to thereby fix the coupling element relative to the counter coupling element or to form an end stop for the second conduit.

6. The coupling element of claim 1, wherein the valve element has a bearing part, wherein a ratio between dimensions of the bearing part in axial direction and dimensions of the bearing part in radial direction is at least 1.5, said bearing part and having at least two bearing surfaces that are spaced apart from each other in axial direction and each rest against an inner circumferential surface of the tubular body.

7. The coupling element of claim 6, wherein the ratio is at least 1.75.

8. The coupling element of claim 6, wherein the ratio is at least 2.0

9. The coupling element of claim 6, wherein the ratio is at least 2.25

10. The coupling element of claim 6, wherein the ratio is at least 2.5.

11. The coupling element of claim 1, wherein the valve element has a closing part, which in the sealing position of the valve element rests against the valve seat and in the release position is spaced apart for the valve seat.

12. The coupling element of claim 1, further comprising a spring exerting a spring force on the valve element, which urges the valve element toward the sealing position.

13. The coupling element of claim 12, wherein the spring exerts the spring force on the closing part of the valve element.

14. The coupling element of claim 12, further comprising a latching body, which is latchingly fastened in the tubular body, wherein on a side of the spring that faces away from the valve element the spring engages on the latching body.

15. The coupling element of claim 12, wherein on the side of the spring that faces away from the valve element the spring is supported on the first conduit.

16. The coupling element of claim 6, wherein the bearing part is traversed in axial direction by a flow channel which is fluidly connected with a radial channel formed between the bearing part and the closing part.

17. The coupling element of claim 6, wherein the valve element has a closing part, which in the sealing position of the valve element rests against the valve seat and in the release position is spaced apart for the valve seat, said bearing part and said closing part being interconnected via at least one web, with the radial channel being arranged adjacent the web or being formed in the web.

18. A coupling arrangement for connecting a first fluid conducting conduit with a second fluid conducting conduit, said coupling arrangement, comprising:
a coupling element, said coupling element comprising a tubular body, a leak protection including a valve element arranged in the tubular body and displaceable in the tubular body between a sealing position in which the valve element rests against a valve seat to inhibit a fluid flow through the coupling element, and a release position in which the valve element is removed from the valve seat to permit a fluid flow through the coupling element; and an actuating arm operably connected to the valve element, said actuating arm being configured to traverse a wall of the tubular body in a radial direction and to extend beyond the tubular body in the radial direction; and
a counter coupling element, wherein the counter coupling element engages with the actuating when the counter coupling is pushed onto the coupling arm so that the valve element is urged from the sealing position in a direction of the release position.
